(19) United States
(12) Patent Application Publication
(10) Pub. No.: US 2002/0070204 A1
(43) Pub. Date: Jun. 13, 2002

(54) Method for making holes in a substrate

(75) Inventors: Guan-Po Chu, Lu Chu Hsiang (TW); Wen-Chung Cheng, Lu Chu Hsiang (TW); Hsin-R Huang, Lu Chu Hsiang (TW)

Correspondence Address: Cooper & Dunham LLP, 1185 Avenue of the Americas, New York, NY, 10036, US

(73) Assignee: Compeq Manufacturing Co., Ltd.

(21) Appl. No.: 09/732,970

(22) Filed: Dec. 8, 2000

(51) Int. Cl. B23K 26/38

(52) U.S. Cl. 219/121.71

(57) ABSTRACT

A method for making holes in a substrate includes steps of cleaning a surface of the substrate and boring the blind holes in the surface of the substrate with laser beams.

### BACKGROUND OF THE INVENTION

1. Field of the Invention

The present invention relates to a method for making blind holes in a substrate and, more particularly, to a method for making blind holes up to a predetermined depth in a substrate.

2. Description of Related Art

It is well known that most substrates of integrated circuits and some printed circuit boards have a plurality of spaced circuits arranged therein one above another. For convenience, these substrates or printed circuit boards are commonly referred to as ‘substrate’ hereinafter.

Referring to FIG. 2, such a substrate (70) is typically made of multiple layers, each layer having a circuit (71, 72) formed on at least one face thereof. The circuits (71, 72) are then electrically interconnected by boring blind holes (710) in the substrate (70), as shown in FIG. 3A, and by plating walls of the holes (710), as shown in FIG. 3B.

Briefly, the circuits (71, 72) in the substrate (70) must be interconnected by boring and plating processes. The necessary blind holes (710) are usually made by laser beams, which have precise energy to penetrate the layer(s) above one particular circuit (72) but not the circuit (72) itself. However, there may be insufficient depth of the blind holes (710) if the energy of the laser beam is absorbed unexpectedly on its way to the real surface of the substrate (70). For example, some of the energy may be absorbed by small pieces of a residual silver layer, retained on the real surface of the substrate (70) after a developing procedure, as well as other foreign matter such as dust and even hair fallen thereon.

Referring to FIGS. 4A and 4B, if the blind holes (710) are not deep enough, the circuits (71, 72) can never be interconnected after the plating process, thus resulting in an unacceptable final product.

Therefore, it is an objective of the invention to provide an improved method for making blind holes in a substrate to mitigate and/or obviate the aforementioned problem.

### SUMMARY OF THE INVENTION

The object of the present invention is to provide a method for making blind holes up to a predetermined depth in a substrate.

Other objects, advantages and novel features of the invention will become more apparent from the following detailed description when taken in conjunction with the accompanying drawings.

### BRIEF DESCRIPTION OF THE DRAWINGS

FIG. 1 is a cross-sectional view of a preferred embodiment of a method in accordance with the present invention for making blind holes up to a predetermined depth in a substrate;

FIG. 2 is a cross-sectional view showing a prior art substrate;

FIG. 3A is a cross-sectional view showing the substrate of FIG. 2 with blind holes;

FIG. 3B is a cross-sectional view showing the substrate of FIG. 2 with plated walls of the blind holes;

FIG. 4A is a cross-sectional view showing a substrate withblind holes of an insufficient depth; and

FIG. 4B is a cross-sectional view showing the substrate of FIG. 4A with plated walls of the blind holes.

### DETAILED DESCRIPTION OF THE PREFERRED EMBODIMENT

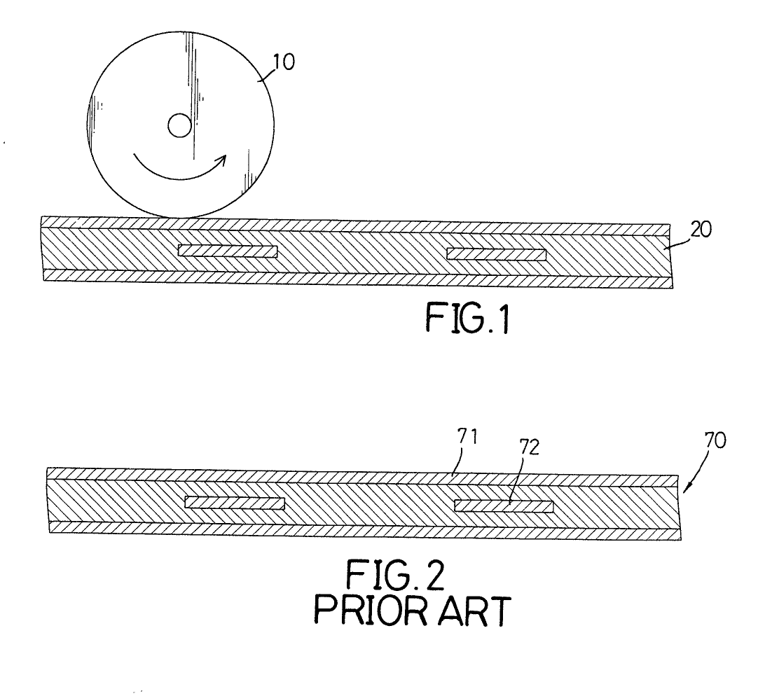

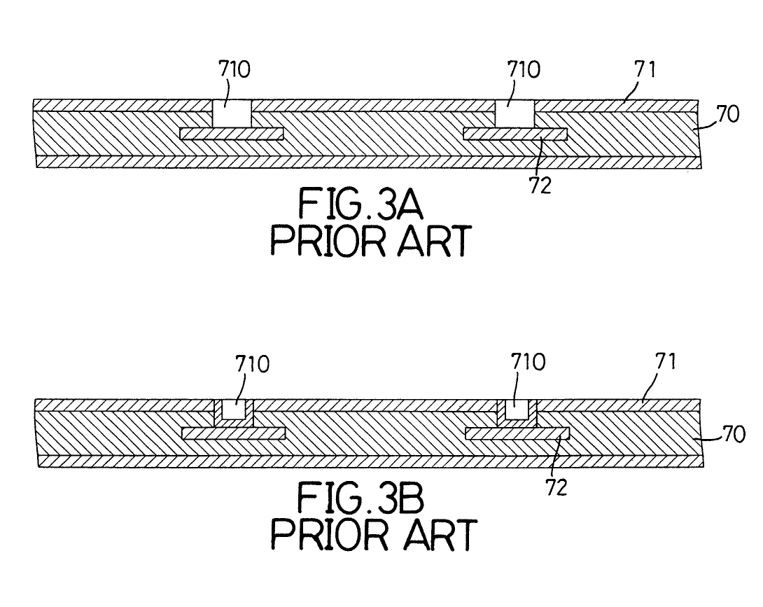

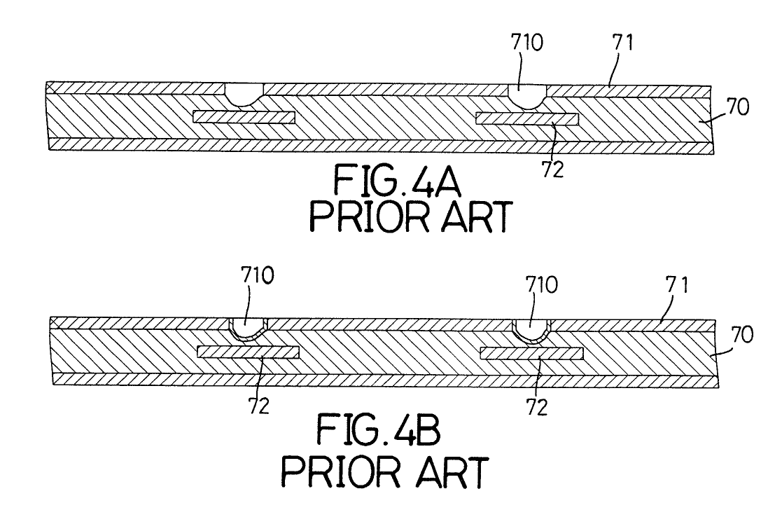

Referring to FIG. 1, a method in accordance with the present invention for making blind holes up to a predetermined depth in a substrate (20) includes steps of cleaning a surface of the substrate (20) and boring the blind holes in the surface of the substrate (20) with laser beams.

The step of cleaning is provided for removing foreign matter, such as dust, small pieces of a residual silver layer and the like, from the surface. This is because the foreign matter reduces the energy of the laser beams reaching the real surface of the substrate (20) and usually results in blind holes with unacceptable depth.

The step of cleaning can be made by means of a cleaner fitted either inside a laser-beam boring machine in which the cleaned substrate (20) is to be moved onto a working table for the step of boring, or outside a laser-beam boring machine into which the cleaned substrate (20) is to be moved for the step of boring.

The cleaner may be a vacuum cleaner, or alternatively, as shown in FIG. 1, may be a cleaner roller (10) that has an adhesive rim or a plurality of bristles adapted to remove the foreign matter from the surface of the substrate (20) when the roller (10) is rolled thereon.

Because of the cleaned surface, the blind holes can be bored up to a determined depth without the risk of accidental reduction in the energy of the laser beams by the foreign matter. This ensures desirable connections between circuits of the substrate (20) during a subsequent process of plating.

The step of cleaning is preferred even when the laser boring is proceeded with the use of a conformal mask method or direct resin drilling method.

From the above description, it is noted that the invention has the advantage of providing a high level of blind holes with the required depth.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A method for making holes in a substrate (20), comprising the steps of:
cleaning a surface of said substrate (20); and
boring said blind holes in said surface of said substrate (20) with laser beams.

2. The method as claimed in claim 1, wherein said step of cleaning is made by a cleaner roller (10) rolled on said surface of said substrate (20).

3. The method as claimed in claim 1, wherein said step of cleaning is made by vacuum cleaner.

4. The method as claimed in claim 1, wherein said step of cleaning is made inside a laser-beam boring machine in which said cleaned substrate (20) is to be moved onto a working table for said step of boring.

5. The method as claimed in claim 1, wherein said step of cleaning is made outside a laser-beam boring machine into which said cleaned substrate (20) is to be moved for said step of boring.
